(19) United States
(12) Patent Application Publication
(10) Pub. No.: US 2020/0128442 A1
(43) Pub. Date: Apr. 23, 2020

(54) JOINT OPTIMIZATION FOR POWER ALLOCATION AND LOAD BALANCING FOR HYBRID VLC/RF NETWORKS

(71) Applicant: King Fahd University of Petroleum and Minerals, Dhahran (SA)

(72) Inventors: Mohanad Obeed, Dhahran (SA); Anas M. Salhab, Dhahran (SA); Salam A. Zummo, Dhahran (SA)

(21) Appl. No.: 16/163,750

(22) Filed: Oct. 18, 2018

(51) Int. Cl. H04W 28/08; H04B 10/079; H04B 10/116; H04W 72/04; H04B 10/114; H04W 72/08

(52) U.S. Cl. CPC H04W 28/085; H04B 10/07955; H04W 72/085; H04W 72/0486; H04B 10/1149; H04B 10/116

(57) ABSTRACT

A joint optimization of power allocation and load balancing for hybrid VLC/RF networks includes one RF access point and multiple visible light communications (VLC) access points and an interactive algorithm to distribute the user's power allocation (PA) and radio-frequency (RF) access points (APs) to the connected users and distributes the power of the APs on the users for the total achievable data rate maximation. In a PA subproblem an optimization problem is formulated to allocate the power of each AP to the connected users for the total achievable data rate maximation. In this subproblem, Applicants propose a new efficient algorithm that finds the optimal dual variables after formulating them in terms of each other. This new algorithm provides faster convergence and better performance than the traditional subgradient method. In addition, it does not depend on the step size and the initial values of the variables.

### FIELD OF THE INVENTION

This invention relates to a joint optimization of power allocation and load balancing for hybrid VLC/RF networks and more particularly to a new joint load balancing (LB) and power allocation (PA) scheme for a hybrid visible light communication (VLC) and radio frequency system consisting of one (RF) access point (AP) and multiple (VLC APs). An iterative algorithm is proposed to distribute the power of the APs on the users.

### BACKGROUND OF THE INVENTION

A patentability search disclosed three articles and applications. To be more specific, a U.S. Patent Application Publication No. 2017/0346559 A1 of Eroglu et al. discloses apparatuses, systems, and methods of communication using visible light communications (VLC). A system can include a VLC transmitter and a VLC receiver suitable for implementing a diversity combining technique. The diversity combining technique can include equal gain combining, selective best combining, and maximal ratio combining. The VLC transmitter can be a multi-element diversity transmitter and can provide illumination as well as data transfer.

A U.S. Patent Application Publication No. 2017/0047994 A1 of Logvinov discloses a visible light and power line communication-based system with location-based services. For example, a hybrid communication network system uses the propagation limitations of visible light communications (VLC) to define location data for portable VLC devices. The location data can be used with a specific location-based profile to provide location-based services to functional zones. The hybrid communications allow location data and connectivity to be available among communications technologies for a hybrid network.

Finally, a U.S. Patent Application Publication No. 2016/0352422 A1 of Yue et al. discloses a communications device including a light-emitting diode (LED) or LED array; an internet protocol (IP)-based radiofrequency (RF) wireless unit, configured to transmit and receive data over a RF wireless communications network; a visible light communication (VLC) unit, configured to drive the LED or LED array and modulate light generated by the LED or LED array with data; a control unit, connected to the IP-based RF wireless unit and the VLC unit, configured to facilitate communications between the VLC unit and IP-based RF wireless unit.

### BRIEF SUMMARY OF THE INVENTION

Applicants propose a new joint load balancing and power allocation scheme for a hybrid visible light communication (VLC) and radio frequency (RF) system consisting of one RF access point (AP) and multiple VLC APs and an iterative algorithm as proposed and to distribute the powers of the access points (APs) on their users. In a power allocation (PA) subproblem an optimization problem is formulated to allocate the power of each AP to the connected users for the total achievable data rate maximation. In this subproblem, Applicants propose a new efficient algorithm that finds the optimal dual variables after formulating them in terms of each other. This new algorithm provides faster convergence and better performance than the traditional subgradient method. In addition, it does not depend on the step size and the initial values of the variables. Users with lower data rates continue re-connecting from AP to other to balance the load only if this travel increases the summation of the achievable data rates and enhances the system fairness. Two approaches are proposed to have the joint PA and LB performed: a main approach that considers the exact interference information for all users, and a suboptimal approach that aims to decrease the complexity of the first approach by considering only the approximate interference information of users. The numerical results demonstrate that the proposed algorithms improve the system capacity and system fairness with fast convergence.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic illustration of a system model of a first embodiment of the invention;

FIG. 2 is a graphical illustration of the comparison between a first proposed algorithm and a sub-gradient method with different step sizes by plotting the violation of the constraints versus number of iterations for AP i, P_{i,max}=10 Watt;

FIG. 3 is a graphical illustration of the comparison between the proposed Algorithm 1 and the sub-gradient method with different step sizes by plotting the system capacity versus number of iterations, P_{i,max}=10 Watt;

FIG. 4 is a graphical illustration showing the convergence of the proposed Algorithm 1 of the user powers connected to AP i and compare it with the subgradient method, step size=0.04, P_{i,max}=10 Watt;

FIG. 5 is a graphical illustration showing the system capacity versus number of iterations for Algorithm 2 with different numbers of system users;

FIG. 6 is a graphical illustration of the system capacity versus number of transferred users for different number of system users;

FIG. 7 is a graphical illustration of the system fairness versus number of transferred users for different number of systems users;

FIG. 8 is a graphical illustration of a comparison between Algorithm 2 and the suboptimal approach in terms of system capacity for different values of α; and

FIG. 9 is a graphical illustration showing the comparison between Algorithm 2 and the suboptimal approach in terms of system fairness for different values of α.

The invention will now be described in connection with the accompanying drawings wherein like reference numbers are used to identify like parts.

DETAILED DESCRIPTION OF THE PREFERRED EMBODIMENTS OF THE INVENTION

### I. Introduction

The growing demand for high data rate and licence free spectrum applications has recently stimulated many researchers to investigate the visible light communication (VLC) as a promising technique for indoor communication. As known, the radio frequency (RF) communications are becoming more restricted because of the limited spectrum resources in wireless networks. As a solution, the VLC has been introduced in indoor environments to overcome the RF limitations and provide better services to the users. The VLC is a communication system that uses a light emitting diode (LED), which is highly energy efficient, as a transmitter to emit both the light and information signals for the users. The receiver must be equipped with a photo detector device that converts the light signal to an electrical signal. Hence, the data is transmitted using an intensity modulation (IM) scheme at the transmitter and received using a direct detection (DD) scheme at the receiver (IM/DD). In addition for being license-free and secure systems, the VLCs are known for their ability to reject RF interference and their high bandwidth potential [1]. On the other hand, the VLC suffers from the blockages. Unlike the RF network, the VLC works properly only when the line of site (LoS) component between the transmitter and receiver is available. Therefore, supplementing the VLC network with a RF AP increases the network coverage and improves the total system capacity [2].

Authors of [3] considered the cooperation between two VLC APs to increase the rate region by controlling the transmission power. In [4], the authors studied the advantages of combining the RF and VLC and showed that the users are distributed dynamically on both the VLC and RF networks based on the user channel condition. Then, the users with lower achievable rates are migrated to the RF system to increase their data rates. To decrease the number of handovers, [5] proposed a dynamic load balancing (LB) scheme where the quasi-static users are connected to VLC APs, while the unfixed users are connected to RF AP. In [6], power and bandwidth allocation was investigated for a system consisting of only one VLC AP and one RF AP which is easy to tackle due to the absence of interference. To study the joint load balancing and resource allocation, [7] proposed a bidirectional allocation game where each user is initially serviced from the AP that provides the highest signal-to-noise ratio (SNR) with time resource allocation. The unsatisfied users are then reconnected to an adjacent AP only in case that it can offer a better service. The procedures of resource allocation and load balancing are repeated, until no more handover occurs.

Up to the Applicants' knowledge, the joint LB and power allocation (PA) for a hybrid VLC/RF network has not been presented or studied before. In this work, Applicants study the two problems of PA and LB in a hybrid VLC/RF network for the sake of data rate maximization and system fairness improvement. The network consists of multiple VLC APs and one RF AP. First, each user is connected to its closest AP. Then, each AP performs its optimization problem (allocates the power for the associated users) in order to maximize the summation of the achievable data rates per AP. After that, the users with the lower data rates start reconnecting from AP to other to balance the load only in case this transfer increases the summation of the achievable data rates. This transfer of users continues until no improvement in the summation of data rates is achieved. In the PA optimization subproblem, we formulate the problem for maximizing the summation of the achievable users data rates under certain QoS constraints. These QoS constraints are formulated to control the tradeoff between the system capacity and system fairness. For a given interference information, the PA problem is proved to be concave but not easy to tackle. Similar PA problems were studied before such as [6], [8] and [9]. In finding the dual variables, in the previous works they used the subgradient decent algorithm, which is very sensitive to step size selection and needs a large number of iterations for convergence. Here, the Applicants derive a new efficient algorithm that finds the optimal dual variables after formulating them in terms of each other. This new algorithm provides faster convergence and better performance than the traditional subgradient method. In addition, it does not depend on the step size and on the initial values of the variables, which we look for, as the subgradient does. The inter-cell interference makes the joint PA and LB problem very difficult. Therefore, two approaches are proposed to have the joint PA and LB implemented: 1) the approach that considers the instantaneous (exact) interference information for all users, 2) and a suboptimal approach that aims to decrease the complexity of the first approach by considering only the approximate interference information of users.

The rest of this work is organized as follows. The system and channel models are introduced in Section II. In Section III, the Applicants present the problem formulation and proposed algorithms. Some simulation results are presented and discussed in Section IV. Finally, the invention is concluded in Section V.

### II. System and Channel Models

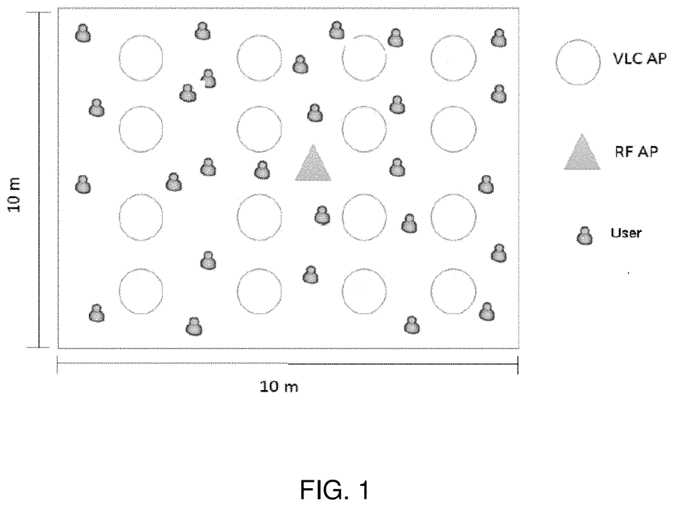

The system under consideration consists of Nₐₚ VLC APs, one RF AP, and Nᵤ users as shown in FIG. 1. The users are distributed uniformly in the room and the APs are fixed in the ceiling of the room. Each VLC AP is equipped with multiple LEDs that use IM to transmit the light signal to the users, which receive the light by a photo detector (PD). The RF AP is assumed to cover all the room area. Also, the location of users are assumed to be unchanged during a short period of interest T. Thus, the VLC and RF channel-state-information (CSI) of both the VLC and RF links is considered to be constant during this period. We assume that the maximum available bandwidth at the AP i is divided fairly among all the users connected to that AP.

A. VLC Channel

The LoS VLC channel between the i^{th} LED and the i^{th} user can be modeled as follows [10]

$${h}_{j , i}^{( v )} = \frac{( m + 1 ) {A}_{p}}{2 π {d}_{j , i}^{2}} {cos}^{m} ( φ ) {g}_{of} f ( θ ) cos ( θ ) , \qquad ( 1 )$$

where m is the Lambertian index that is given by m=−1/log₂(cos(θ/_{1/2}), where θ_{1/2} is the half intensity radiation angle, Aₚ is the physical area of the receiver PD, d_{j,i} is the distance between the i^{th} AP to the j^{th} user, g_{of} is the gain of the optical filter, φ is the angle of radiance at the AP, θ is the angle of incidence at the PD, and ƒ(θ) is the optical concentrator gain, which is a function of θ that is given by

$$f ( θ ) = \{ \begin{matrix}\frac{{n}^{2}}{{sin}^{2} ( Θ )} , & 0 \leq θ \leq Θ ; \\ 0 , & θ > Θ ,\end{matrix} \qquad ( 2 )$$

where n is the refractive index and Θ is the semi-angle of the field-of-view (FoV) of PD. In a VLC network, the LED has to operate in the linear region so that the optical power at its output is a linear function of the input voltage. The non-LoS VLC transmissions are assumed to be unsuccessful so that we work only on LoS paths. This assumption does not affect the proposed algorithm since it does not depend on a specific channel model. Therefore, when the LoS path is available, h^{(ν)} is given by (1); otherwise, h^{(ν)}=0. The probability of the availability of the LoS from an AP to a user is denoted by α and it is assumed to be uniformly distributed. It was shown in [6] that the average electrical power of the received signal at user j from the VLC AP i is calculated as follows

P_{elec,j,i}=(ρ\sqrt{P_{j,i}^{(ν)}}h_{j,i}^{(ν)})², (3)

where p is the optical-to-electric conversion efficiency, P^{(ν)} is the allocated power for user j from the AP i, where P^{(ν)} is the maximum transmitted optical power of the AP i. The received SNR at user j from the VLC AP i can be expressed as

$${Γ}_{j , i}^{( v )} = \frac{{( ρ \sqrt{{P}_{j , i}^{( v )}} {h}_{j , i}^{( v )} )}^{2}}{( {B}_{i , max}^{( v )} \text{/} {N}_{i} ) {N}_{0}^{( v )} + {ρ}^{2} {\sum }_{l = 1 , l \neq i}^{{N}_{p}} {P}_{{B}_{j , i}}^{( v )} {h}_{j , l}^{( v ) 2}} , \qquad ( 4 )$$

where B^{(ν)} i,max is the maximum available bandwidth at the AP i, Nᵢ is the number of users connected to the AP i, N^{(ν)} 0 is the noise power spectral density, and P^{(ν)} Bj,l is the interference power at user j caused by the AP l. It is worth to note that P^{(ν)} Bj,l must be calculated carefully since it represents the power allocated from the AP l to the same frequency spectrum that is allocated for user j. For instance, if the AP i is associated with 4 users, and user j along with another user are connected to AP i, P^{(ν)} Bj,l should be calculated as the summation of the powers of 2 users out of the 4 users that are connected to the AP l and use the same spectrum frequency used by user j.

Here, Shannon's capacity equation is used to express the achievable data rate that represents a limit for the performance without considering specific modulation and coding schemes. This equation is employed due to its mathematical tractability since using different modulation schemes does not affect significantly the optimality of the achieved data rate [11]. Therefore, the maximum data rate that can be achieved at user j from the VLC AP i is given by

R_{j,i}^{(ν)}=(B_{i,max}^{(ν)}/Nᵢ)log₂(1+Γ_{j,i}^{(ν)}). (5)

B. RF Channel

As mentioned before, the RF cell is assumed to cover all the room area and a spectrum of a total bandwidth B^{(r)} max at the RF AP is considered to be flat fading and can be partitioned into non-overlapping channels of unequal bandwidths. According to [2], the RF channel gain between user j and the RF AP is expressed as

$${h}_{j}^{( r )} = \sqrt{{10}^{- \frac{L ( d )}{10}}} ( \sqrt{\frac{K}{K + 1}} {h}_{d} + \sqrt{\frac{1}{K + 1}} {h}_{s} ) , \qquad ( 6 )$$

where K=10 dB is the Rician factor for indoor 60 GHz mmWave links, h_{d}=0:5(1+j) is the LoS fading channel, hₛ is a circular normal distributed with zero mean and unity variance and it is the fading channel of the scattered path, and L(d) is the corresponding large-scale fading loss in decibels at the separation distance d, given by

L(d)=L(d₀)+10ν log₁₀(d/d₀)+Z, (7)

where L(d₀)=68 dB is the reference path loss at some reference distance d₀=1 m, ν=1.6 is the path loss exponent, and Z is the shadowing component, which is assumed to be a zero mean Gaussian distributed random variable with a standard deviation of 1:8 dB. The shadowing effect induced by human bodies in the proximity of the mmWave radio links is omitted [2]. The data rate achieved by the RF link between user j and the RF AP can be expressed as

$${Γ}_{j}^{( r )} = \frac{{P}_{j}^{( r )} {\vert {h}_{j}^{( r )} \vert}^{2}}{( {B}_{max}^{( r )} \text{/} {N}_{r} ) {N}_{0}^{( r )}} , \qquad ( 8 )$$

where B^{(r)} max is the maximum available bandwidth at the RF AP and Nᵣ is the number of users connected to the RF AP. The achievable data rate that can be achieved by user j from the RF AP is given by

Rⱼ^{(r)}=(Bₘₐₓ^{(r)}/Nᵣ)log₂(1+Γⱼ^{(r)}). (9)

### III. Problem Formulation

The problem here is how to assign all the users to the APs and how to allocate the APs powers for the assigned users aiming to maximize the system capacity with keeping the fairness between the users at an acceptable level. Therefore, we start by assigning the users based on their distance from the APs, where each user selects the closest AP to it. Then, each AP performs its own power allocation problem for its associated users.

The achievable data rate of user j is expressed as

$${R}_{j , i} = \{ \begin{matrix}{R}_{j , i}^{( v )} , & i ∈ {C}_{v} ; \\ {R}_{j , i}^{( r )} , & i ∈ {C}_{r} ,\end{matrix} \qquad ( 10 )$$

where C_{ν} denotes the set of the VLC APs and Cᵣ denotes the RF AP.

A. Power Allocation in VLC and RF Access Points

In this section, we aim to allocate the power for the Nᵢ users that are connected to the AP i. The objective function here is to maximize the summation of the users data rates under certain QoS constraints. These constraints are formulated to guarantee some fairness for users per APs. We formulate the optimization problem as a general form for the VLC APs or the RF AP. Hence, [P_{j,i}B_{j,i}h_{j,i}N₀]=[P^{(ν)}_{j,i}(B^{(ν)}_{i,max}/Nᵢ)ph^{(ν)}_{j,i}N₀^{(ν)}], if the AP i is a VLC AP, and if the AP i is a RF AP, so [P_{j,i}B_{j,i}h_{j,i}N₀]=[P^{(r)}ⱼ(B^{(r)}ₘₐₓ/Nᵣ)h^{(r)}ⱼN^{(r)}₀]. Therefore, the optimization problem of the AP i can be expressed as

$$\begin{matrix}{max}_{{P}_{1 , i , .. , {P}_{{N}_{i}} , i}} {\sum }_{j = 1}^{{N}_{i}} {R}_{j , i} & ( 11 a ) \\ s . t . {R}_{j , i} \geq {γ}_{j , i} , j = 1 , .. , {N}_{i} & ( 11 b ) \\ {\sum }_{j = 1}^{{N}_{i}} {P}_{j , i} \leq {P}_{i , max} , & ( 11 c ) \\ {P}_{j , i} \geq 0 ∀ j , & ( 11 d )\end{matrix}$$

where Nᵢ is the number of users associated with the AP i, and γ_{j,i} is the minimum data rate that can be achieved at user j from the AP i, which is given by

$${γ}_{j , i} = β \frac{{B}_{i , max}}{{N}_{i}} log ( 1 + \frac{( {P}_{i , max} \text{/} {N}_{i} ) {\vert {h}_{j , i} \vert}^{2}}{( {B}_{i , max} \text{/} {N}_{i} ) {N}_{0} + {X}_{j , i}} ) , \qquad ( 12 )$$

where X_{j,i} is the interference term of user j and is equal to p²Σ_{l=1,l≠i}^{Np}P_{B,j,l}^{(ν)}h_{j,l}^{(ν)2} if the AP i is VLC, and in the case of RF AP, X_{j,i}=0, and β is a value in the interval [0, 1]. If we select β=1, this means that the AP will distribute its resources fairly (regardless of users channels), where each user gains the same power P_{i,max}/Nᵢ and same bandwidth B_{i,max}/Nᵢ. On the other hand, if β is close to zero, this means that the objective function is released from the first constraint, which leads to increase the AP capacity.

Jain's fairness index is used to measure the AP fairness and the whole system fairness. Therefore, the fairness of the AP i is given by

$${F}_{i} = \frac{{( {\sum }_{j = 1}^{{N}_{i}} {R}_{j , i} )}^{2}}{{N}_{i} {\sum }_{j = 1}^{{N}_{i}} {R}_{j , i}^{2}} , \qquad ( 13 )$$

and the fairness of the system is given by

$${F}_{s} = \frac{{( {\sum }_{i = 1}^{{N}_{ap}} {\sum }_{j = 1}^{{N}_{i}} {R}_{j , i} )}^{2}}{{N}_{ap} {\sum }_{i = 1}^{{N}_{ap}} {\sum }_{j = 1}^{{N}_{i}} {R}_{j , i}^{2}} . \qquad ( 14 )$$

The Problem in (11) is not easy to tackle since in the case where the AP i is a VLC AP, the interference term in the objective function makes the problem difficult. On the other hand, if the interference terms are given, the Problem in (11) becomes a concave problem and can be solved by using the Lagrangian dual problem. First, we solve this problem under the assumption that the interference terms are given then we provide an iterative algorithm that achieves the optimal power allocation. Obviously, the Constraints in (11c) and (11d) are linear functions, while the objective function and the Constraint in (11b) are well known as concave functions as shown in [6] and [9]. Therefore, the optimization Problem in (11) is a concave problem with one global optimum solution. Hence, we can use the dual problem to achieve the optimal solution, where the strong duality holds in the concave problems. The dual optimization problem of the Problem in (11) can be expressed as follows

$$ζ = - {\sum }_{j = 1}^{{N}_{i}} {R}_{j , i} - {\sum }_{j = 1}^{{N}_{i}} {μ}_{j , i} ( {R}_{j , i} - {γ}_{j , i} ) + {v}_{i} ( {\sum }_{j = 1}^{{N}_{i}} {P}_{j , i} - {P}_{i , max} ) , \qquad ( 15 )$$

where μⱼ is the Lagrangian multiplier for the data rate constraint of the j^{th} user and νᵢ is the Lagrangian multiplier for the total power constraint.

In the following, an efficient algorithm is proposed to solve the Problem in (11) by minimizing the dual problem in (15). From the Karush-Kuhn-Tucker (KKT) conditions [12], we have

$$\begin{matrix}\frac{\partial ζ}{\partial {P}_{j , i}} = 0 , \\ where & ( 16 ) \\ {P}_{j , i} = \frac{( 1 + {μ}_{j , i} ) {B}_{j , i}}{{v}_{i} ln ( 2 )} - \frac{{N}_{0} {B}_{j , i} + {X}_{j , i}}{{\vert {h}_{j , i} \vert}^{2}} , & ( 17 )\end{matrix}$$

where the variable μ_{j,i} must guarantee that the Constraint in (11b) is feasible and νᵢ must guarantee that the Constraint in (11c) is feasible too. Now, these dual variables must be found to obtain P_{j,i}∀ⱼ. In [6] and [9], the authors found such dual variables by using the gradient decent method, which is an iterative algorithm that needs a large number of iterations to converge and a very careful selection of the step size. Here, we find a closed-form expression for νᵢ in terms of μ_{j,i} and vise versa. Then, we solve them alternatively until they converge. First, it is trivial showing that the Constraints in (11c) must hold with equality at optimality. Otherwise, we can increase one of the power variables until the constraints hold with equality, which leads to increasing the objective function, and hence, contradicting the optimality. By substituting (17) in (11c), we have

$${v}_{i} = \frac{{\sum }_{j = 1}^{{N}_{i}} {B}_{j , i} ( 1 + {μ}_{j , i} )}{ln ( 2 ) ( {P}_{i , max} + {\sum }_{j = 1}^{{N}_{i}} \frac{{B}_{j , i} {N}_{0} + {X}_{j , i}}{{\vert {h}_{j , i} \vert}^{2}} )} . \qquad ( 18 )$$

Similarly, by substituting (17) in (11b), μ_{j,i} must be

$${μ}_{j , i} \geq \frac{{v}_{i} ln ( 2 ) {P}_{j , i}^{min}}{{B}_{j , i}} + \frac{{v}_{i} ln ( 2 ) ( {B}_{j , i} {N}_{0} + {X}_{j , i} )}{{B}_{j , i} {\vert {h}_{j , i} \vert}^{2}} - 1 , \qquad ( 19 )$$

where P_{j,i}^{min} is given by

$${P}_{j , i}^{min} = \frac{( {2}^{( {γ}_{j , i} \text{/} {B}_{j , i} )} - 1 ) ( {B}_{j , i} {N}_{0} + {X}_{j , i} )}{{\vert {h}_{j , i} \vert}^{2}} , j = 1 , .. , {N}_{i} , \qquad ( 20 )$$

which is the minimum required power to achieve Constraints (11b). Hence, (18) and (19) depend on each other and can be solved alternatively starting from an initial value of one of them until they converge. After that, (17) is used to find the optimal power allocation. Algorithm 1 is proposed to solve the optimization problem in (11) with a given interference information. Condition 5 in Algorithm 1 examines the convergence

Algorithm 1 Power allocation for the AP i.

```
1) Input B_{j,i}, μ_{j,i}(0) ∀j.
2) for q = 1 : M
3) Find vᵢ(q) from (18) and ∀j, calculate P_{j,i}.
4) For all j, check if the calculated P_{j,i} ≥ P_{j,i}^{min}. If so,
  μ_{j,i}(q) = μ_{j,i}(q − 1); otherwise, calculate μ_{j,i}(q) from
  (19) by equating both sides, then update P_{j,i}.
5) If |vᵢ(q) − vᵢ(q − 1)| ≤ ϵ, break;
6) end for
7) Find P_{j,i} ∀j using (17).
```

of all dual variables νᵢ and μ_{j,i}, j=1, 2, . . . , Nᵢ.

1) Convergence analysis: Here, we analyze Algorithm 1 in terms of convergence. Before we start analyzing the convergence, we should note that the values of P_{j,i}∀ⱼ after Step 3 are different from the values of P_{j,i}∀ⱼ after step 4 (i.e., the values of P_{j,i}∀j change twice in the same iteration). To avoid this confusion, we denote the values of P_{j,i}∀j after Step 3 by P_{j,i}⁽³⁾ and denote the values of P_{j,i}∀j after Step 4 by P_{j,i}⁽⁴⁾.

At any q^{th} iteration, it can be shown that in Step 3, the variable νᵢ(q) steers the the summation of powers to be equal to P_{i,max} (i.e., to achieve Constraint (11c) with equality). In other words, if we find νᵢ(q) at Step 3 and substitute it in (17) ∀j, we find that Σⱼ₌₁^{Ni}P_{j,i}⁽³⁾(q)=P_{i,max}. On the other hand, Step 4 implies that each P_{j,i}⁽³⁾ that is less than the corresponding P_{j,i}^{(min)} (i.e. each P_{j,i}⁽³⁾ that does not satisfy the corresponding constraint in (11b)) is increased by increasing the associated μ_{j,i}, to achieve that P_{j,i}⁽⁴⁾(q)=P_{j,i}^{(min)}. This increase in power yields violating Constraint (11c) to be as Σⱼ₌₁^{Ni}P_{j,i}⁽⁴⁾(q)≥P_{i,max}. Hence, in the (q+1)^{th} iteration, νᵢ(q+1) will be greater than νi(q) to have that Σⱼ₌₁^{Ni}P_{j,i}⁽³⁾(q+1)=P_{i,max} again.

Without loss of generality, we assume that in the q^{th} iteration, P_{j,i}(q)<P_{j,i}^{(min)} for j=1, . . . , k−1 and P_{j,i}(q)≥P_{j,i}^{(min)} for j=k, . . . , Nᵢ. From (17), we note that the increase in νᵢ leads to decreasing each P_{j,i}⁽³⁾∀j with keeping the constraint Σⱼ₌₁^{Ni}P_{j,i}⁽³⁾(q+1)=P_{i,max} satisfied. Hence, we have that P_{j,i}⁽³⁾(q+1)<P_{j,i}⁽³⁾(q), j≤K, . . . Nᵢ ) because Step 4 causes no change in these powers in the iteration q), and P_{j,i}⁽³⁾(q+1)>P_{j,i}⁽³⁾(q), j=1, . . . , k−1 to keep the constraint Σⱼ₌₁^{Ni}P_{j,i}⁽³⁾(q+1)=P_{i,max}. satisfied. This means that μ_{j,i}(q+1) must be increased to achieve the constraint P_{j,i}⁽⁴⁾(q+1)=P_{j,i}^{(min)}, j=1, . . . , k−1 but with less amount than what was required in μ_{j,i}(q). Consequently, with implementing one iteration more, we have

μ_{j,i}(q+2)−μ_{j,i}(q+1)<μ_{j,i}(q+1)−μ_{j,i}(q), j=1, . . . , k−1. (21)

Similarly,

νᵢ(q+2)−νᵢ(q+1)<νᵢ(q+1)−νᵢ(q), (22)

Therefore, as the number of iterations increases, the amount of change in νᵢ and all μ_{j,i}∀j approaches zero. Thus, Algorithm 1 is convergent.

It is also important to note that in Equation (19), νᵢ is a factor of the expression 1+μ_{j,i}, which means that starting with any initial values for μ_{j,i} will be compensated by νᵢ to have the same value of P_{j,i} as Equation (17) shows. Hence, Algorithm 1 does not depend on the initial values.

2) Finding the exact interference information: Now, in the VLC APs, the problem is how to find the instantaneous interference (X_{j,i}) of each user, which is difficult to be found because the term X_{j,i} of user j depends on all powers of the APs that are allocated for the j^{th} user frequency spectrum. Therefore, we provide an iterative algorithm that solves the PA problem of all the VLC APs with finding the instantaneous interference of each user. Algorithm 2 provides the optimal power allocation for a given distributed users. It is worth stating that the RF AP performs its power allocation using Algorithm 1 and it is not included in Algorithm 2. This is because the interference of the users connected to the RF AP is zero.

Algorithm 2 Power allocation for all the VLC APs with a
given distributed users.

1) Each AP allocates the power for the users equally.
2) for q = 1 : M
3) Calculate X_{j,i}^{(q)} for all users in the system.
4) Perform Algorithm 1 for all APs.
5) if Σᵢ₌₁^{N}ₚ Σⱼ₌₁^{N}ᵢ (X_{j,i}^{(q)} − X_{j,i}^{(q-1)})² ≤ ϵ; break;
6) End for

B. Load Balancing

As stated earlier, initially, each user is connected to its closest AP. Then, each AP performs its own power allocation problem as shown in the previous section. However, some APs will be overloaded, which may cause some users connected to these APs to receive a poor QoS. Therefore, after the PA optimization problem (Algorithm 2) is performed, the user with the poorest QoS is reconnected to either the RF AP or another adjacent VLC AP if the later can provide a better service and increase the system capacity. The users connected to the RF AP do not receive any interference so that the strongest candidate AP for the user (which needs to reconnect to another AP) to travel to is the RF AP. The approach here is to arrange the users as a queue starting from the user with the lowest QoS up to the highest quality serviced user. Then, each user in its turn tests if the RF AP can provide a better achievable data rate for it or not. If so, the user migrates to the RF AP; otherwise, the user transfers to another adjacent AP if that AP can provide a better achievable data rate for him. These procedures continue until no improvement in the system capacity can be achieved. From the PA Problem in (11), each VLC AP offers for each user its QoS denoted by γ_{j,i}, which is a function of the number of users connected to that AP as shown in (12). Hence, the maximum offered achievable data rate for user j that is connected to the AP i is given by

$${\overline{R}}_{j , k} = {max}_{k ∈ {ϰ}_{i}} ( {γ}_{j , k} ) , \qquad ( 23 )$$

where Xᵢ is the set of the APs that are very close to the AP i and Nₖ<Nᵢ−1∀k. Since γ_{j,k}, depends on the value of β, if Nₖ=0, that means the AP k offers all its resources for the coming user, and hence, β=1 in (23). Otherwise; if Nₖ≥1, β is determined by the AP k. It is important to state that the transfer of a user connection changes the interference information, which enforces the system to re-implement Algorithm 2 with each transfer. This process of transfer continues only if there is an improvement in the system capacity.

C. Suboptimal Approach: Averaging the Interference

The disadvantage of the above approach is its high complexity since with each user connection transfer, all the APs must perform the power allocation problem, which is highly complex. The reason behind that is the need for exact interference information to implement both the PA and LB together. In this section, we aim to simplify the problem solution by relaxing this demand. User j experiences interference from each AP with a power that might be less or greater than the average power. This average power is calculated under the assumption that each AP distributes its power equally for its associated users. Therefore, the essence of the approach here is that instead of obtaining the instantaneous interference, we obtain the average interference that is calculated by averaging the power of the interference coming from all the APs. Therefore, the approximate inter-cell interference at user j that is connected to the AP i is given by

$${X}_{j , i} = {\sum }_{l = 1 , l \neq i}^{{N}_{p}} \frac{{P}_{l , max}}{{N}_{i}} {h}_{j , l}^{2} . \qquad ( 24 )$$

The above assumption significantly simplifies the problem as there is no need to implement the PA optimization at all the APs at each user connection transfer. In other words, we only need to perform the PA optimization problem (Algorithm 1) at only two APs (the departed from and the arrived to APs).

IV. Simulation Results

In this section, we verify the capability of the proposed algorithms for enhancing the performance of the hybrid VLC/RF network. We show the convergence of the proposed algorithms and how they increase the system capacity. A 10×10 room area is assumed with 16 VLC APs and 1 RF AP fixed in the ceiling. The values of all parameters in the considered VLC/RF system are given in Table I. Monte-Carlo simulation is used to assess the performance of the proposed algorithms where in each simulation iteration, a uniform random number is generated between 0 and 1. If that number is less than α (the probability of the availability of the LoS), the LoS component is available; otherwise, LoS component is not available.

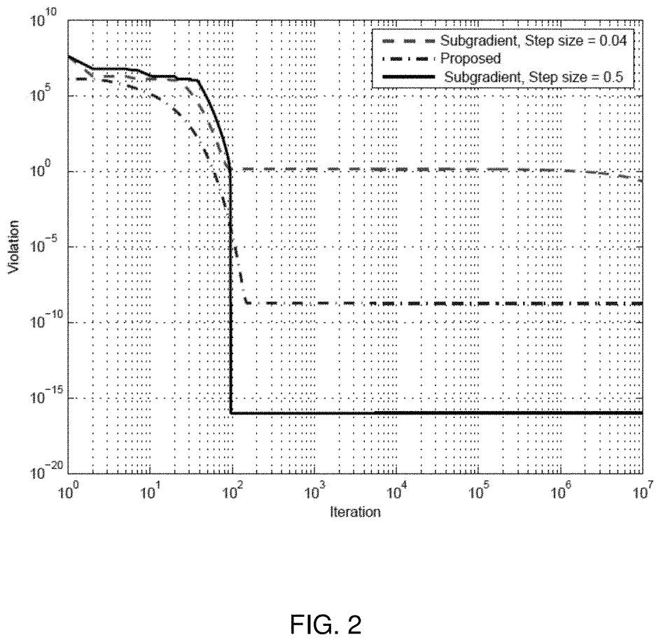

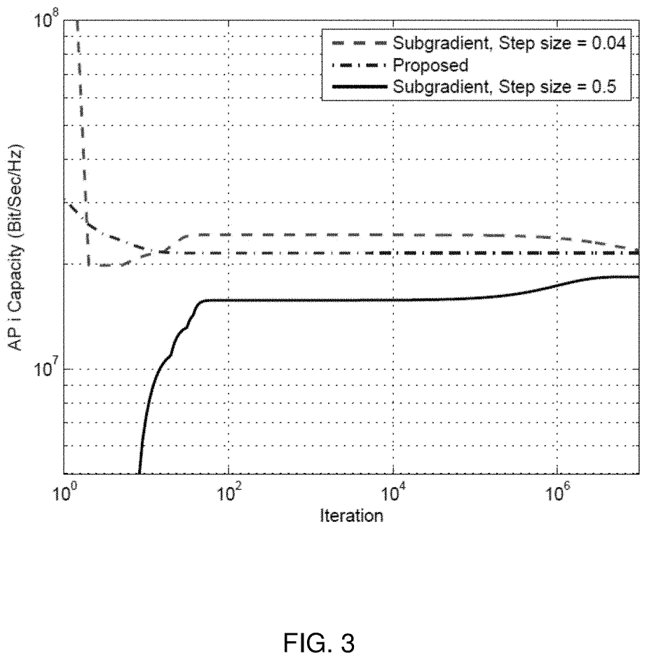

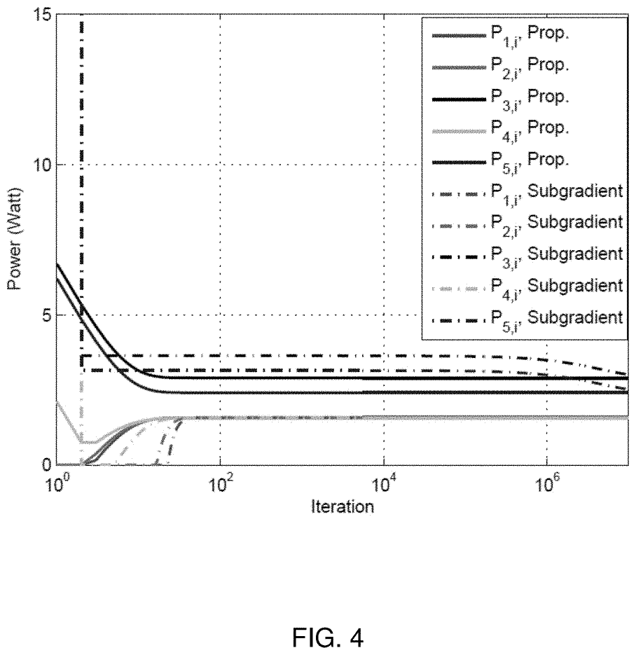

In FIG. 2 and FIG. 3, we show the performance and convergence of the proposed Algorithm 1 implemented at AP i and compare it with the subgradient method. Both figures should be analyzed together because FIG. 2 shows the maximum constraint violation of the approaches (i.e., how much the approaches are close from achieving the constraints versus the number of iterations), while FIG. 3 shows the value of the objective function for the different approaches versus the number of iterations. It is observed that the subgradient method with large step size (step size =0.5) achieves the constraints slightly faster than the proposed approach as shown in FIG. 2, but it cannot achieve the same system capacity as the proposed approach can achieve as shown in FIG. 3. In other words, if we assume that the violation tolerance is 10⁻⁴, both approaches, the proposed and the subgradient with large step size, almost satisfy the constraints after 100 iterations, while the proposed approach provides higher AP capacity than the subgradient method as shown in FIG. 3. On the other hand, the subgradient method with small step size (step size=0.04) starts to satisfy the constraints after more than 10⁷ iterations as shown in FIG. 2, and after that huge number of iterations, it starts approaching the capacity achieved by the proposed approach as shown in FIG. 3. It is known that in the subgradient method, the smaller step size, the closer optimal values we obtain as the number of iterations goes to infinity. Hence, as shown in FIG. 4, the proposed approach provides the same power values of the subgradient method (step size=0.04) in less than 100 iterations, while the subgradient method achieves some of those values after 107 iterations. FIG. 4 also shows that the subgradient method violates the maximum power constraints over a wide range of iterations and it starts satisfying that constraint after huge number of iterations (10 million iterations).

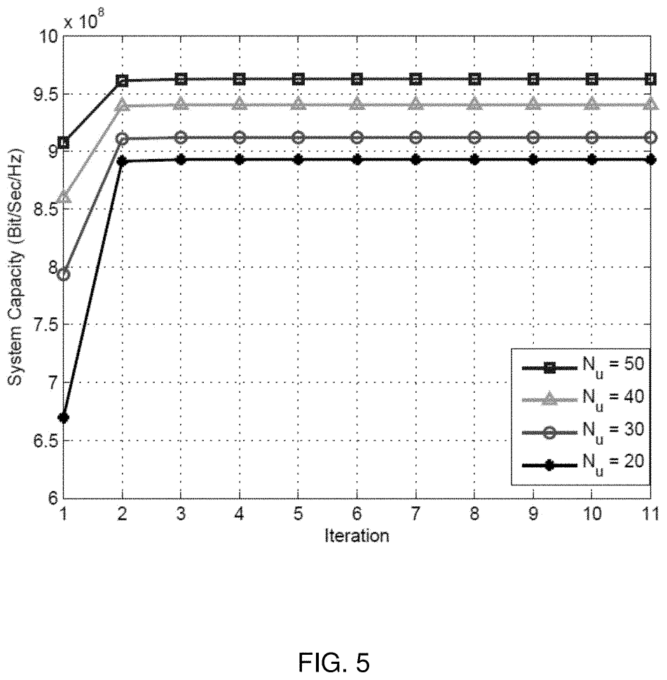

FIG. 5 shows the convergence of Algorithm 2. It is clear that Algorithms 2 needs at most three iterations to converge. Furthermore, the number of iterations needed to converge does not depend on the number of users in the system, which means that the number of users does not affect the convergence of Algorithm 2. This indicates that Algorithm 2 rapidly converges to the optimal solution.

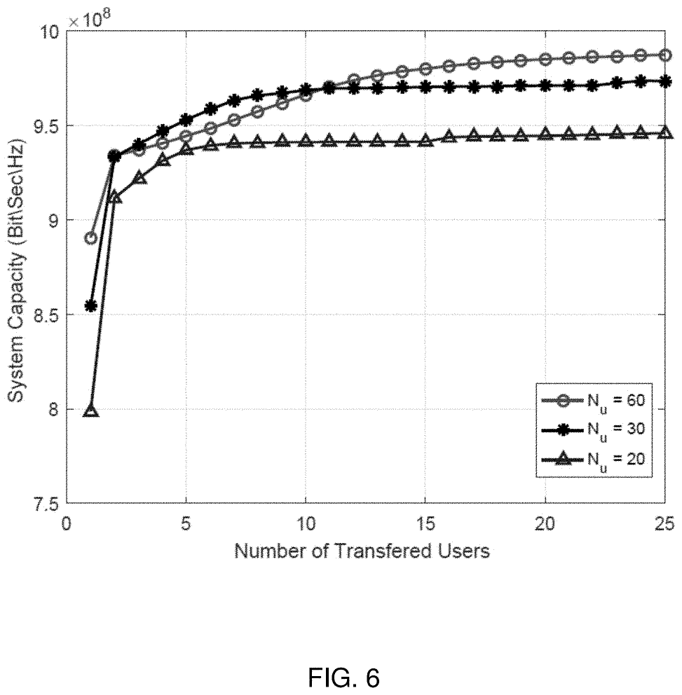

In FIG. 6, the relation between the system capacity and number of reconnected users is shown with different numbers of total users. It can be seen that the more the users transfers, the better the system capacity till the system saturates. Also, it is obvious that more user's transfers are needed for the system to reach the saturation point as the number of users increases, as expected. In other words, the rate of increasing the system capacity with 60 users is less than the rate of increasing the system capacity with 20 or 40 users.

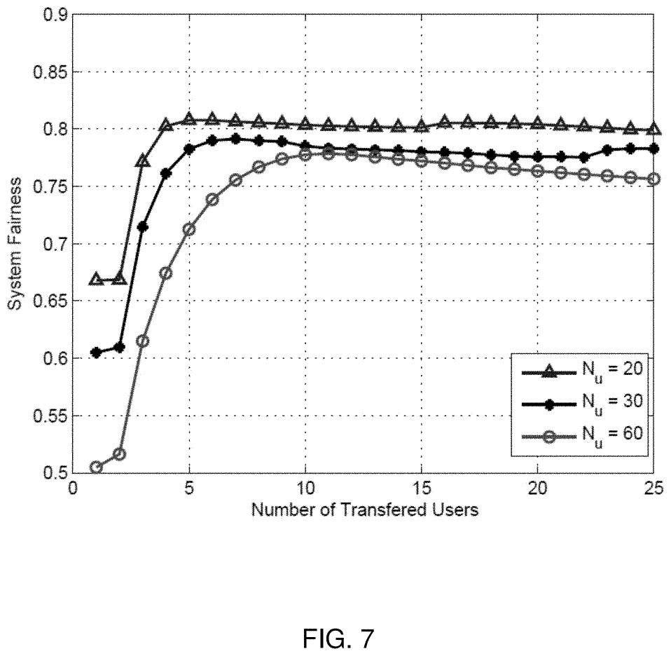

The impact of total number of users on the system fairness is studied in FIG. 7. It is clear from this figure that as the number of transferred users increases, the system fairness is more enhanced with the best results achieved at the minimum number of total users. Enhancing the system fairness and capacity together with each user transfer comes from the fact that the users with poor services travel from the overloaded APs to have better services from other less overloaded APs. This helps in decreasing the variance of the received data rate among users and provides a more efficient utilization of APs resources.

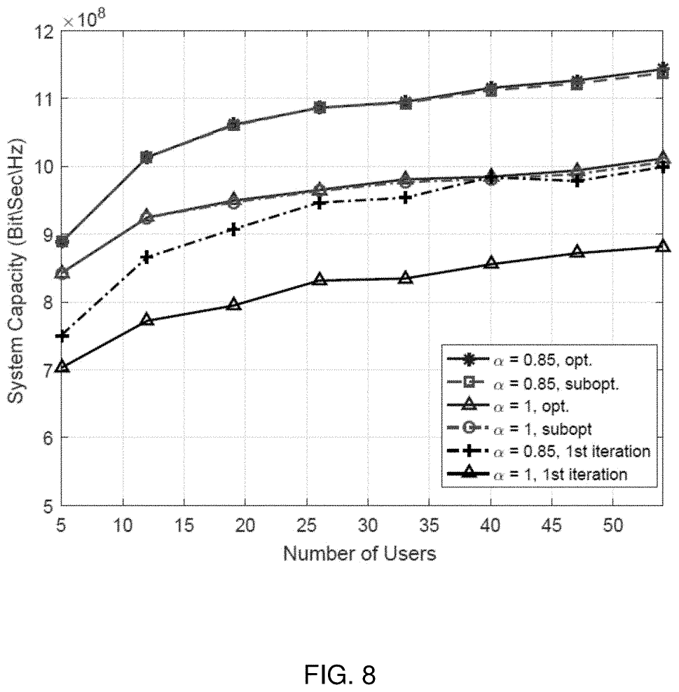

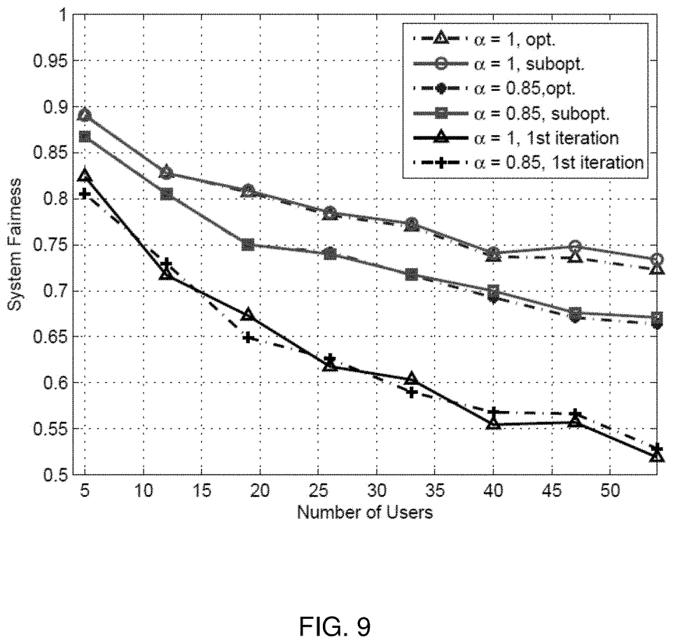

FIG. 8 shows the relation between the number of users and the total system capacity for different values of α. It is shown that the difference between the performance of Algorithm 2 and the suboptimal solution (averaging the interference) is negligible. We also investigate the effect of number of users on the system fairness in FIG. 9. The approach that considers the approximate interference information slightly performs better than the approach that considers the exact interference in terms of the system fairness. This is due to the fact that the former depends on calculating interference matrix based on the assumption that the power at the APs is distributed fairly among users, which leads to a more fair power allocation among users than the later. As can be seen from FIG. 8 and FIG. 9, as the probability of the LoS availability decreases, the system capacity increases while the fairness decreases. This is because increasing the blockages rate in the hybrid VLC/RF networks can enhance the system capacity rather than compromising it. In other words, the blockages are more likely to prevent the users from receiving the optical interference than blocking the intended signals. On the other hand, blocking some users from some VLC APs increases the variance of the received data rates among users which leads to decrease the system fairness. The figures show also how the proposed joint LB and PA algorithms significant improve the system capacity and fairness compared to the case where one iteration is implemented only (each user is assigned to its closest AP and each AP implements the PA only once).

V. Conclusion

In this work, a joint LB and PA algorithms for hybrid RF/VLC network were proposed. An iterative algorithm was proposed to maximize the total system capacity and enhance the system fairness. Two approaches were implemented: 1) the approach that is based on the exact interference information for all users, which provided better performance, 2) and a suboptimal approach that is based on the approximate interference information, which had a less complexity compared to the first approach. In the PA subproblem, we derived a new efficient algorithm that finds the optimal dual variables after formulating them in terms of each other. This new algorithm provided a faster convergence and a better performance than the traditional subgradient method.

### REFERENCES

[1] C.-L. Tsai and Z.-F. Xu, “Line-of-sight visible light communications with InGaN-based resonant cavity LEDs,” IEEE Photon. Technol. Lett., vol. 25, no. 18, pp. 1793-1796, 2013.
[2] Y. Wang, D. A. Basnayaka, and H. Haas, “Dynamic load balancing for hybrid Li-Fi and RF indoor networks,” in Proc. IEEE Int. Conf. Commun. Workshop (ICCW), London, UK, 2015, pp. 1422-1427.
[3] M. Kashef, M. Abdallah, K. Qaraqe, H. Haas, and M. Uysal, “On the benefits of cooperation via power control in OFDM-based visible light communication systems,” in Proc. IEEE Personal, Indoor, and Mobile Radio Commun. (PIMRC) Conf., Washington, D.C., USA, September 2014, pp. 856-860.
[4] D. A. Basnayaka and H. Haas, “Hybrid RF and VLC systems: Improving user data rate performance of VLC systems,” in Proc. IEEE Veh. Technol. Conf. (VTC Spring), Glasgow, UK, May 2015, pp. 1-5.
[5] Y. Wang and H. Haas, “Dynamic load balancing with handover in hybrid Li-Fi and Wi-Fi networks,” IEEE/OSA J. Lightw. Technol., vol. 33, no. 22, pp. 4671-4682, November 2015.
[6] M. Kashef, M. Ismail, M. Abdallah, K. A. Qaraqe, and E. Serpedin, “Energy efficient resource allocation for mixed RF/VLC heterogeneous wireless networks,” IEEE J. Selec. Areas Commun., vol. 34, no. 4, pp. 883-893, 2016.
[7] X. Wu, M. Safari, and H. Haas, “Bidirectional allocation game in visible light communications,” in Proc. IEEE Veh. Technol. Conf. (VTC Spring), Montreal, Canada, 2016, pp. 1-5.
[8] D. W. K. Ng, E. S. Lo, and R. Schober, “Energy-efficient resource allocation in multi-cell ofdma systems with limited backhaul capacity,” IEEE Trans. Wirel. Commun., vol. 11, no. 10, pp. 3618-3631, 2012.
[9] H. Wang, A. Liu, and X. Pan, “Optimization of joint power and bandwidth allocation in multi-spot-beam satellite communication systems,” Math. Problems in Eng., vol. 2014, 2014.
[10] J. M. Kahn and J. R. Barry, “Wireless infrared communications,” Proc. IEEE, vol. 85, no. 2, pp. 265-298, 1997.
[11] W. Guo, S. Wang, and X. Chu, “Capacity expression and power allocation for arbitrary modulation and coding rates,” in Proc. IEEE Wireless Commun. and Netw. Conf. (WCNC), Shanghai, China, 2013, pp. 3294-3299.
[12] S. Boyd and L. Vandenberghe, Convex Optimization. Cambridge University Press, 2004.
[13] X. Li, R. Zhang, and L. Hanzo, “Cooperative load balancing in hybrid visible light communications and WiFi,” IEEE Trans. Commun., vol. 63, no. 4, pp. 1319-1329, 2015.
[14] Y. Wang, X. Wu, and H. Haas, “Load balancing game with shadowing effect for indoor hybrid lifi/rf networks,” IEEE Trans. Wirel. Commun., vol. 16, no. 4, pp. 2366-2378, April 2017.
[15] R. K. Mondal, M. Z. Chowdhury, N. Saha, and Y. M. Jang, “Interferenceaware optical resource allocation in visible light communication,” in Proc. Int. Conf. ICT Convergence (ICTC), Jeju, Korea (South), October 2012, pp. 155-158.
[16] M. Grant and S. Boyd, “Cvx: Matlab software for disciplined convex programming,” 2008.
[17] X. Li, Y. Huo, R. Zhang, and L. Hanzo, “User-centric visible light communications for energy-efficient scalable video streaming,” IEEE Trans. Green Commun. and Netw, vol. 1, no. 1, pp. 59-73, 2017.
[18] X. Wu, M. Safari, and H. Haas, “Joint optimisation of load balancing and handover for hybrid LiFi and WiFi networks,” in Proc. IEEE Wireless Commun. and Netw. Conf. (WCNC). IEEE, 2017, pp. 1-5.

What is claimed is:

1. Joint optimization of power allocation and load balancing for hybrid VLC/RF networks comprising:
one RF access point (AP) and multiple visible light communications (VLC) access points (APs);
an iterative algorithm to distribute the user's power allocation (PA) and radio frequency (RF) access points (APs) to the connected users and distributes the power of the APs on the users for the total achievable data rate maximation.

2. A new efficient power allocation algorithm for VLC or RF systems, where the dual variables are formulated in terms of each other, and an iterative steps must be implemented.

3. A new efficient power allocation algorithm according to claim 2, in which it provides faster convergence and better performance than the traditional subgradient method, and does not depend on the step size and on the initial values of the variables, which we look for, as the subgradient does.

4. A joint optimization of power allocation and load balancing for hybrid VLC/RF networks according to claim 1, in which the VLC suffers from blockages and unlike the RF network, the VLC works properly only when the line of sight (LoS) component between the transmitter and receiver is available thus supplementing the VLC network with a RF AP increases the network coverage and improves the total system capacity.

5. A joint optimization of power allocation and load balancing for hybrid VLC/RF networks according to claim 1, wherein the user's with lower achievable rates are migrated to the RF system to increase their data rates and decrease the number of handovers.

6. A joint optimization of power allocation and load balancing for hybrid VLC/RF networks according to claim 1, in which a propose dynamic load balancing scheme includes a proposed dynamic load balancing (LB) scheme where the quasi-static users are connected to VLC APs while the unfix users are connected to RF AP.

7. A joint optimization of power allocation and load balancing for hybrid VLC/RF networks according to claim 1, in which the joint load balancing and power allocation for a hybrid VLC/RF network has not been presented or studied and wherein the two problems of power allocation and load balancing in a hybrid VLC/RF network for the sake of data rate maximation and system fairness improvement and wherein the network consists of multiple VLC APs.
